(19) United States
(12) Patent Application Publication
(10) Pub. No.: US 2005/0245161 A1
(43) Pub. Date: Nov. 3, 2005

(54) Thermo durable and high performance natural fiber molded composites manufacturing process

(76) Inventors: Mohini M. Sain, Toronto (CA); Tayebeh Behzad, Toronto (CA)

Correspondence Address: MOHINI M. SAIN;FACULTY OF FORESTRY, 33 WILLCOCKS STREET, TORONTO, ON, M5S 3B3, CA

(21) Appl. No.: 11/082,499

(22) Filed: Mar. 18, 2005

Related U.S. Application Data
(60) Provisional application No. 60/562,444, filed on Apr. 16, 2004.

(51) Int. Cl. D01C 5/00; B32B 21/02; B32B 1/00; B32B 25/02; B32B 21/10; D21J 1/00; D04H 1/00; B32B 27/12; D04H 1/74; D01F 9/12; D04H 3/05; B32B 5/24; D02G 3/00; B32B 27/00

(52) U.S. Cl. 442/374; 442/334; 442/369; 428/220; 428/292.4; 428/295.1; 428/301.4; 428/393; 428/394

(57) ABSTRACT

The present invention relates to a process for the manufacture of non-woven short or long lignocellulosic fiber thermoset based composites, in which the process consists of forming natural fiber mats in a perforated screen, further impregnation of the lignocellulosic fibers by circulating the thermoset solution and applying vacuum pressure to drain the excess solution, further drying the prepreg mat at a temperature range of 30 to 100 degree centigrade for 0.5 to 48 hours, further compression molding under pressure of 10 to 50 tones and a temperature range of 50 to 240 degree centigrade for 1 to 30 minutes and cooling the mold to less than 60 degree centigrade under the same pressure into composite products. The said composites have a flexural strength of 94 MPa and a flexural modulus of 14 GPa. The invention also relates to the use of the said composites in cosmetic, semi-structural and structural applications.

### BACKGROUND OF THE INVENTION

The present invention relates to a process for the manufacture of a moldable non-woven short or long lignocellulosic fiber thermoset resin impregnated mat and where after compression molded into composite product with improved properties, preferably flexural modulus of 14 GPa and flexural strength of 94 MPa. The said process consisting of three stages: forming non-woven plant fiber mat in a perforated screen, further impregnating the mat with the resin solution, circulation of the solution to obtain uniform distribution and further applying vacuum to drain excess solution and drying to a moldable cellulosic thermoset impregnated mat. The present invention also related to said polymer composite product manufactured by the said process and to the use of the product within cosmetic, semi-structural and structural applications of automotive, furniture and other industries.

Natural fiber reinforced composites are an emerging area in polymer science. By embedding natural fibers into polymeric matrix; a new fiber reinforced material were formed and are still being developed. The natural fibers serve as reinforcement by enhancing the strength and stiffness to the resulting composite structure. Their moderate mechanical properties prevent the fibers from using them in high-performance applications, but for many reasons they can compete with glass fibers. For instance, their low specific weight result in higher specific strength and stiffness than those for glass. Natural fibers are also renewable resources and their production requires low energy along with CO₂ consumption and oxygen production. Natural fibers are producible with low investment and at low cost which makes the material an interesting product on large scales.

The matrix plays an important role in the performance of the composites. Both thermosets and thermoplastics are attractive as matrix materials for composites. Lots of work has been done on different methods for producing fiber reinforced materials. Most of the work reported involves in thermoplastics such as polyethylene, polypropylene and poly vinyl chloride. Li et.al in U.S. Pat. No. 4,393,020 claimed a method for manufacturing a molded article from a fiber-reinforced thermoplastic polymer. This method involves two steps: first polymerization of the monomers and second compression molding of the product. A natural fiber composite was produced using a starch ester as a matrix and microfibers of cellulose as reinforcement and a composite with superior mechanical properties was obtained by Narayan in U.S. Pat. No. 5,728,824. Moreover, DuCharme et.al in U.S. Pat. No. 5,603,884 disclosed a method of preparing an extruded cellulosic film which contains a uniform dispersion of hemp fibers and a molten aqueous solution of cellulose and amine oxide cellulose solvent as a thermoplastic matrix.

Thermoset composite materials are chemically cured to a highly cross-linked three-dimensional network structure. Due to this structure, thermoset composites are highly solvent resistant with superior mechanical properties. For example, a method for producing natural fiber reinforced thermoset materials was explained by Skwiercz et.al in U.S. Pat. No. 6,682,673. The matrix was provided by radical polymerization reactions using monomers from natural resources and reinforced with flax fibers. Also, Taylor in U.S. Pat. No. 6,204,312 developed a process for manufacturing organic and inorganic compositions with thermoset resins and formed to desired shape using injection molding and extrusion. Most of the work on thermoset composites used resin transfer molding (RTM) process to manufacture the composites. Rouison et.al, (Composites Science and technology, 64, 5, 629-644, 2004), manufactured hemp/kenaf fiber-unsaturated polyester composites using RTM process and obtained fast and homogeneous curing of the part. Also, Williams et.al, (Applied Composite Materials, 7, 421-432, 2000), developed a new composite contains fibers and thermoset resin from natural resources using RTM process. The maximum fiber content in RTM process can not be more than 40% because of difficulty in filling the mold.

There is a large potential for energy saving and reduction of environmental impact in the use of natural fibers as reinforcements in polymer composites for many applications, provided that the full reinforcement potential of these fibers is exploited. One of the major issues in development of composites is dispersion of the fibers in the matrix. The incorporation of cellulosic fibers in polymers leads to poor dispersion of the fibers due to strong inter-fiber hydrogen bonding, which holds the fibers together. This lack of fiber dispersion can result in clumping and agglomeration of cellulose fibers which lead to inferior mechanical properties. In the case of using thermoplastic polymers as a matrix, this problem can be overcome by pretreatment of the fibers with polymer coating. Polymer coatings on fiber surfaces help to separate fibers from each other, eliminating the hydrogen bonding. This approach also induces bond formation between fibers and the matrix which have different polarities. For example, Scandola et.al in U.S. Pat. No. 6,667,366 described the chemical modification of the surface of natural fibers to enhance the adhesion between matrix and fibers. However, in the case of using thermoset polymers as a matrix, eliminating the hydroxyl groups on the surface of fibers also will decrease the interaction between fibers and matrix which result poor composite properties. In the present research, different processes were conducted to prepare resin impregnated lignocellulosic mats using for compression molding processes. Hence, a unique processing technique has been developed for manufacturing natural fiber composites using thermoset resins and non-woven lignocellulosic/ cellulosic fibers.

### BRIEF SUMMARY OF THE INVENTION

The present invention is a process for manufacturing improved moldable thermoset material, where short or discontinuous natural fibers are properly impregnated with thermoset polymer, subsequently compression molded into composite product with improved properties, with a flexural strength of 94 MPa and a flexural modulus of 14 GPa. More specifically, the present invention relates to a process for the manufacture of a polymer composite product with acceptable properties, said product consisting of one or more layers of thermoset impregnated natural fiber mat, in which the fibers are in the form of non-woven mats where after, the lay-up is subjected to an elevated temperature, pressure and time followed by cooling under pressure to produce a composite product. The process of the invention is characterized in that the fibrous layers are impregnated by circulating the diluted solution of thermoset polymer through the fibers and employing a vacuum pressure simultaneously to obtain a uniform penetration of polymer through the layer and drain the excess solution. After impregnation, the prepreg mats are dried at specific temperature and time and then ready to cure at the specific temperature and pressure for certain time using compression molding process followed by cooling stage to obtain the final composite products. This approach will be extendable to a wide variety of fiber/polymer combinations.

The thermoset material is preferably water based polymer such as acrylic polymer, but other water soluble and insoluble resins and low viscose thermoset materials are useful as well, typically vinyl ester resin, unsaturated polyesters and their low molecular weight precursors. Precursors are further prone to polymerization.

The fibrous reinforcement in the composite product manufactured by the process of the invention consists of either:

Plant fibers selected among hemp, flax, jute, sisal, kenaf.

Wood or cellulose fibers

Blends of the natural fibers mentioned in [1] and /or [2] or

The said object of the present invention is the manufacturing process comprising the following steps:

Formation of the plant fiber mat in a perforated screen which is connected to a vacuum system and dilution of the polymer at a specific resin content ranging between 5 to 30 weight percentages.

Circulation of the polymer solution through the fibers to obtain uniform distribution of wetting in the mat for 0.5-15 minutes and where after application of the vacuum pressure in the range of 50-1000 pound per square inch (psi) to drain the excess solution for 0.1-10 minutes.

Drying the prepreg mat at a temperature range of 30-100 degree centigrade for 0.5 to 48 hours to evaporate all of the water contents.

Compression molding of the moldable resin impregnated lignocellulosic fiber mat at a temperature range of 50 to 240 degree centigrade under pressure ranging from 10 to 50 tones for 1 to 30 minutes and cooling to a temperature less than 60 degree centigrade under the same pressure in to composite products.

The present invention provides a number of advantages over the prior process, including:

Using non-woven fibers versus woven mat improve the penetration uniformity of the polymer through the fibers because of the lower compaction of the fibers

Using the vacuum pressure increase the wetting surface of fibers

Better performance of the composite through better interfacial wetting of the natural fibers with the thermoset

Simple and practical method for high production rate

Manufacturing composites with high fiber content is applicable

Non-woven fibers are more randomly oriented as a result the final product is more isotropic

Extra solution of thermoset solution can be recycled

The process and the products according to the invention will find use within a number of different fields of industry. One of the key areas will be the automotive industry. In Europe the automotive industry has taken a major lead in using plant fiber composites in automotive interiors. The industry has been particularly interested in the environmental advantages of such composites. The weight and cost advantages of these composites are also particularly important to the industry.

The main benefit of the technology that forms the basis of the present invention in contrast to the known techniques is the ability to maximize the mechanical properties through the vacuum impregnation technique. Although this is practiced manually in laboratory scale, the process will be amenable to semi-continuous and continuous application through feeding of loose fibers and circulation of polymer solution to provide prepreg mat and then drying and final compression molding.

### BRIEF DESCRIPTION OF THE DRAWINGS

FIG. 1: Spray lay-up system

FIG. 2: Blower system

FIG. 3: Spray-drying system

FIG. 4: a) Mat formation, b) Mat impregnation, and c) Vacuum filtration

FIG. 5: Tensile and flexural strength of the composite versus temperature

FIG. 6: Tensile and flexural modulus of the composite versus temperature

FIG. 7: Tensile and flexural strength of the composite versus time

FIG. 8: Tensile and flexural modulus of the composite versus time

FIG. 9: Tensile and flexural strength of the pure polymer and composite versus fiber length

FIG. 10: Tensile and flexural modulus of the pure polymer and composite versus fiber length

### DETAILED DESCRIPTION OF THE INVENTION

As mentioned earlier, the key aspect of the present invention is based upon a specific technique to produce composites with optimum properties which consists of one or more layers of prepreg natural fibers mats. It is primarily the reinforcing fibers which give the composite product its desirable properties, where as the matrix material must be capable of transferring any stress between the fibers. The adhesion and wetting surface between the fibers and the matrix material is therefore crucial to the properties of the product. In natural fibers, strong inter-fiber hydrogen bonding leads to a poor dispersion of fibers into the matrix and as a result less wetting of fibers. To overcome this problem, different processes were conducted for diluted thermoset polymers to prepare resin impregnated mats followed by compression molding process. Finally a unique process technique has been developed using vacuum impregnation. The processing techniques are described as follow:

1. Spray Hand Lay-Up Process

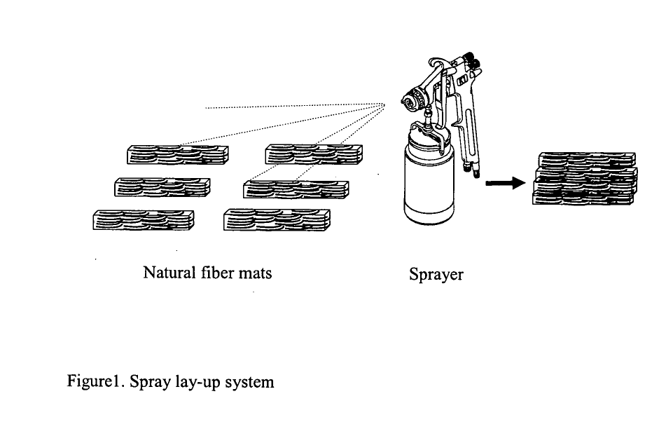

In this process, the required non-woven natural fibers were divided equally into 1-13 layers into square shapes manually. A 1-30 wt % diluted solution of resin were prepared and sprayed over the upper surface of each layer (FIG. 1). The layers were kept at room temperature for 0-48 hrs to dry and then laid together to prepare a composite with 50% resin and 50% fiber contents. The composite was cured at 50-180° C. for 1-60 min at 10 to 50 tones pressure using a hydraulic hot press. Due to the lack of resin dispersion and non uniformity of the composite the inferior mechanical properties were obtained. For instance, the flexural strength was approximately 5 MPa.

2. Air Blowing System

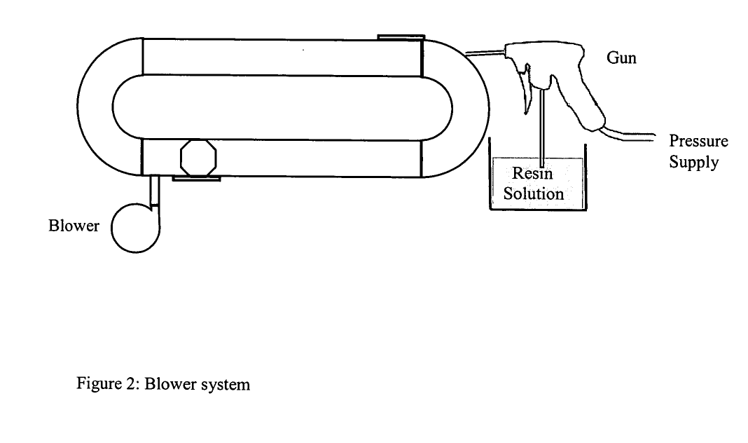

In this technique, a circulated pipe system was designed to separate fibers by blowing force. Steel pipes with the inner diameter of 6 inches were connected to each other and two exits were considered at two different points. A blower with 2-3.5 hp was utilized to supply required force to separate the fibers and drying them after spraying the resin solution. A small transparent window was placed to observe movement of fibers. A nozzle was located at the corner point of the system to spray the resin solution while fibers were circulating (FIG. 2). Small amount of fibers were placed into the system and exits were closed and the blower was switched on. Due to high hygroscopic and hydrophilic nature of cellulose fibers even with high power of blower, the fibers were entangled and moved together. As a result, a poor distribution of resin and fiber were obtained.

3. Spray-Drying of the Resin Fiber Slurry

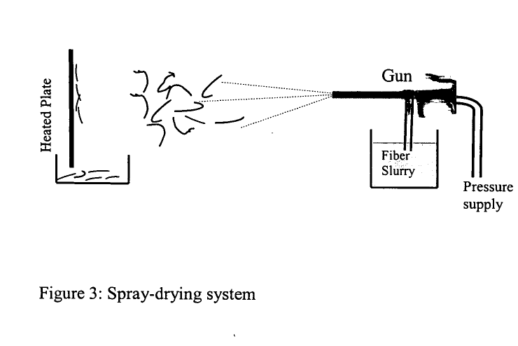

In this technique, slurry of fiber was prepared by dispersing the fibers in the diluted resin solution with a consistency of 1-5 wt %. A compressed air gun with a maximum inner diameter of 4 mm was used to spray the slurry (FIG. 3). By regulating the air pressure, a venture effect is created by which suction is generated in the tube which connected to the gun. The slurry was sprayed toward a heated surface, which allowed the fibers to partially dry before coming into contact with each other and finished with a fluffy of resin impregnated fibers. Because of using relatively long fibers, the fibers were twisted inside the gun and then blocked the outlet of the gun after few minutes spraying. Although with this method a good distribution of fibers and resin can be obtained, it will be practical in the case of using very short fibers in a very low consistency of slurry. Therefore, this process is not suitable for industrial purposes due to low production rate (5 g/hr) and limitation.

4. Vacuum Impregnation

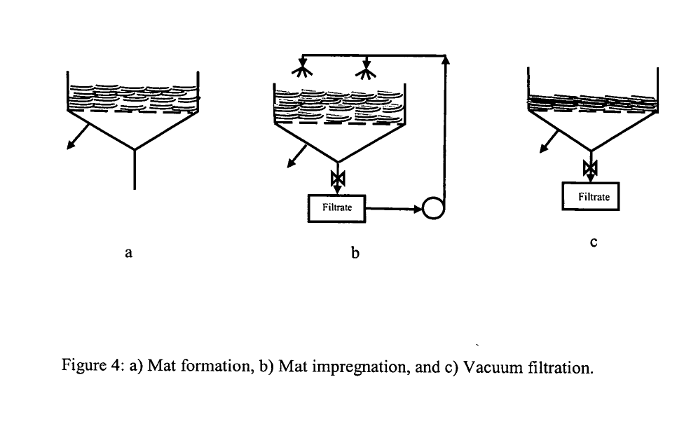

Non-woven lignocellulosic fibers were randomly oriented manually in a Buckner funnel which connected to a vacuum system (FIG. 4a). A resin solution with 5-30% resin content was prepared by adding solvent to resin to circulate through the fibers. The said resin solution was spread all over the fibers and circulated for 0.3-15 minutes to impregnate the fibers with the solution (FIG. 4b). In the last stage, vacuum pressure in the range of 50-1000 psi was applied to drain the excess solution (FIG. 4c). Vacuum time can be varied ranging from 0.1-10 minutes depends on the required composition of the material. The initial weight of the said solution and the weight of solution in the filtrate were measured to calculate the amount of adsorbed solution to the fibers. After circulation of the resin solution, the wet mat was removed from Buckner and placed on a non-stick sheet and then kept in the oven at the temperature of 30-100° C. for 0.5-48 hours to remove all moisture content. The mat would be ready for compression molding process after drying.

Finally, to manufacture the composite the impregnated mat was cured at the temperature of 50-240° C. for 1-30 minutes using a hydraulic press in pressure of 10-50 tones. One or more layers of mats were combined together to reach to desirable finishing thickness. After heating cycle, the temperature of the composite was cooled down to a temperature less than 60° C. using water cooling system to prevent any blister formation due to any moisture content. The final composite was removed from the press and prepared for mechanical properties measurements.

Testing

Composite panels were cut into sections allowing for at least three tensile and flexural test specimens in each case. The tensile properties of the composites were measured following the ASTM standard method (D-638). The flexural properties were obtained according to the ASTM standard method (D-790). Also the ASTM D-256 was applied to measure the notched impact properties of samples.

### EXAMPLES

Materials:

The fiber used in these experiments was hemp fibers in the form of non-woven loose fiber. The moisture content was in the range of 4 to 12% weight percentage. The polymer employed in these experiments was an environmentally friendly water-based acrylic thermoset polymer (viscosity at 23° C.=400-4000 mP·s).

The following examples are illustrative of some of the moldable non-woven cellulosic thermoset resin impregnated mat and composite products comprising lignocellulosic fibers and the method of making the same within the scope of the present invention.

### Example 1

### Processing of a Moldable Non-Woven Cellulosic Thermoset Mat by Vacuum Impregnation

Bast fibers, prefereably non-woven hemp with an average length of 2.5 centimeter and 9 centimeter were selected and 28 grams of fibers randomly oriented in a Buckner funnel with the inner diameter of 19 cm which connected to a vacuum system. A resin solution with 10 weight percentage of resin prepared by adding water as a solvent to an environmentally friendly acrylic resin to circulate through the fibers. The resin solution was circulated for 5 minutes to impregnate all the fibers with the solution. In the last stage, 2 minutes vacuum filtration was applied to remove the excess solution and keep almost 185 gram of the resin solution inside the fibers to have a composite with 40% resin content. After circulation of the resin solution, the wet mat was removed from Buckner and placed on the polyester sheet and then kept in the oven at 55° C. for 36 hrs to remove all moisture content. The mat would be ready for compression molding process after drying. Two layers of the dry impregnated mat were combined together and cured at 180° C. for 10 min using hydraulic press under 30 tones pressure to reach to almost 2.2 millimeter thickness. After heating cycle, the composite was cooled down under same pressure to around 50° C. using cold water system. The final composite was removed from the press and prepared for mechanical properties measurements.

### Example 2

### Compression Processing of a Moldable Non-Woven Cellulosic Resin Impregnated Mat Under Various Processing Condition

The vacuum resin impregnation processing of the non-woven cellulosic mats are the same as mentioned in example 1.

In one case, the moldable non-woven cellulosic resin impregnated mats were molded at different temperatures of 175, 180, 185 degree centigrade for 12 minutes

In the other case, the moldable non-woven cellulosic resin impregnated mats were molded at the temperature of 180 degree centigrade for two different times 10 and 12 minutes.

In the other case, the moldable non-woven cellulosic resin impregnated mat were manufactured for two different fiber lengths 2.5 and 9 centimeter and molded at the temperature of 180 degree centigrade for 10 minutes.

### Example 3

### Compression Processing a Moldable Non-Woven Cellulosic Resin Impregnated Mat Using a Prototype Mold

The vacuum resin impregnation processing of the non-woven cellulosic mats are the same as mentioned in example 1.

Having acceptable mechanical properties, a prototype mold was designed and built for an exterior mirror frame of automobile. The stainless steel mold contains two male and female parts was installed onto the platens of the hydraulic press. A moldable non-woven cellulosic resin impregnated mat obtained from example 1 was molded using the above mentioned mold at the temperature of 180 degree centigrade for 10 minutes under the pressure of 30 tones. Curvatures of the specimen clearly show a good formability of the composite especially at the corners.

### RESULTS

Typical performance properties of the composite are shown in Table 1. The composite consists of 40% polymer and 60% fiber (9 cm) cured at 180° C. for 10 min under 30 tones pressure and cooling to less than 50° C.

TABLE 1
Mechanical properties of hemp fiber acrylic based composite

| Performance | ASTM | Average | Maximum | Minimum | |
|---|---|---|---|---|---|
| property | Test | Value | Value | Value | SD |
| Tensile Strength | D-638 | 42.21 | 46.14 | 37.59 | 3.7 |
| (MPa) | | | | | |
| Tensile Modulus | D-638 | 5.1 | 5.15 | 4.7 | 0.25 |
| (GPa) | | | | | |
| Flexural Strength | D-790 | 93 | 110.16 | 82.31 | 10.9 |
| (MPa) | | | | | |
| Flexural Modulus | D-790 | 14.5 | 15.4 | 13.8 | 0.67 |
| (GPa) | | | | | |
| Notch Izod (J/m) | D-256 | 46 | 48.6 | 43.13 | 2.76 |

Influence of Cure Temperature

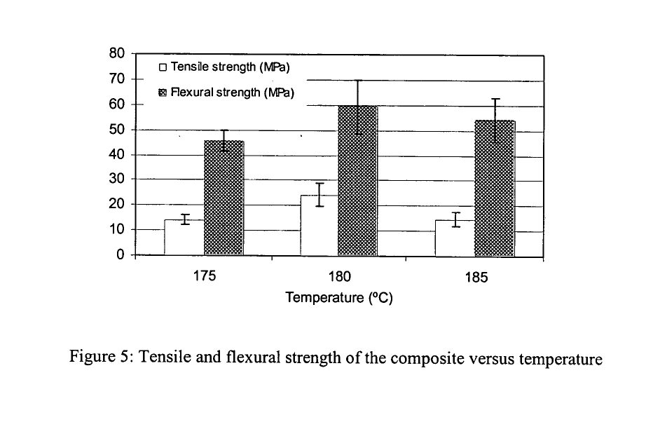

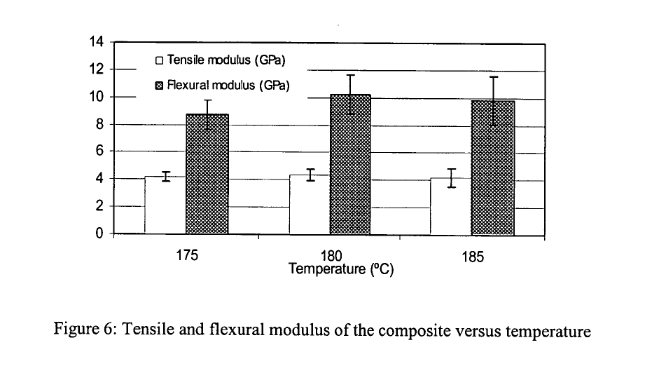

The effect of cure temperature on the performance of the composite was shown in FIGS. 5 and 6. The mechanical properties of the composites consists of 40% polymer and 60% short fiber (2.5 cm) cured at different curing temperatures 175, 180, and 185° C. for 12 min were evaluated to obtain the optimum curing temperature. As it can be noticed, the composite cured at 180° C. has superior mechanical properties compare with others. That means at this temperature, strong adhesion between fiber and matrix due to higher crosslinking resulted in higher strength at the fiber/matrix interface.

Influence of Cure Time

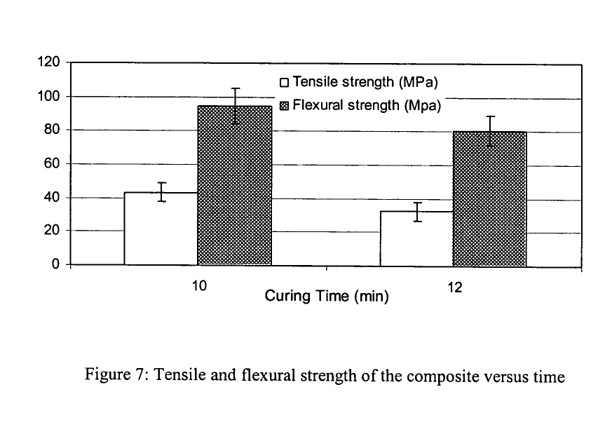

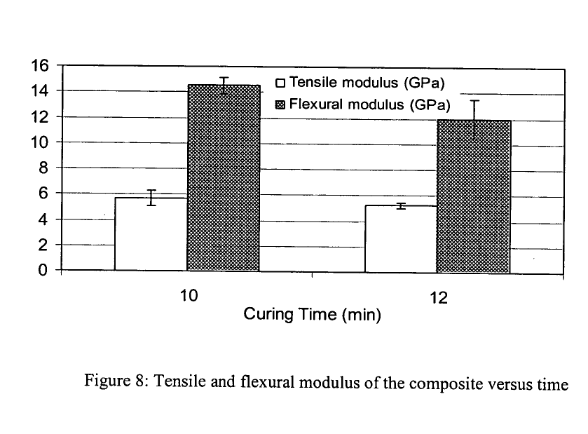

The effect of cure time on the performance of the composite was shown in FIGS. 7 and 8. The mechanical properties of the composites consists of 40 percentage of weight polymer and 60 percentage of weight long fiber (9 cm) cured at the curing temperature of 180 degree centigrade at two different curing times 10 and 12 min were evaluated to obtain the optimum curing time. As it can be noticed, the composite cured for 10 min has superior mechanical properties compare with another which can be due to decomposition of the resin in longer time.

Influence of Fiber Length

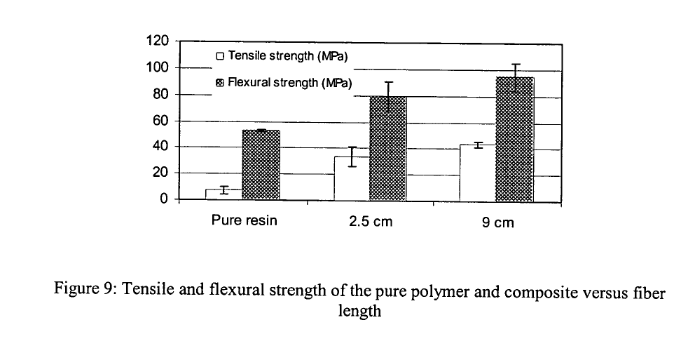

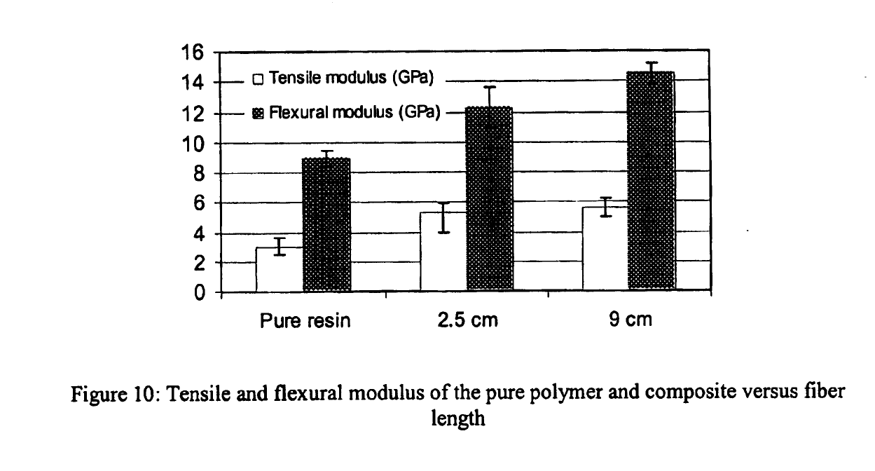

The mechanical properties of the cured pure polymer and the effect of fibers on the performance of the polymer were evaluated as shown in FIGS. 9 and 10. As it can be noticed, adding 60 percentage of weight fiber to the pure resin has a pronounced effect on the mechanical properties of the polymer. When polymer resin stressed, random flaws in physical structure of the resin will cause the material to crack and fail. Introducing the fibers to the resin will overcome this problem and reinforce the material.

In order to investigate the effect of fiber length on the performance of the composite, two different fiber lengths (short and long) were selected (2.5 cm and 9 cm) and the composites were manufactured with two layers of impregnated mat at 180 degree centigrade for 10 min with 40 percentage of weight resin and 60 percentage of weight fiber. From the figures, for the same amount of fiber content, as the fiber length increases the number of stress concentrating fiber ends decreases which assist to transfer load from matrix to the fiber and thus contributes toward the entire composite and consequently improvement in mechanical properties.

Influence of Adhesion Promoter

Adhesion promoters such as styrene-maleimide and polysiloxane are used to treat the fiber. In a typical composition 0.2 to 3% of the adhesion promoters are used to treat the fibers. Treatment is carried out by spraying either on the bed in a non aqueous medium or they were dissolved in water and then spayed over the fiber bed. A maximum improvement of 15% of flexural strength was observed for composites made with thermosetting resins using the fiber treatment process as described above.

In yet another process liquid resin polyester, acrylic or vinyl ester is mixed with the strength promoters such as polysiloxanes including 3-aminopropyltriethoxysilane, Styrene maliec anhydride resins (SMA 1000, SMA 40001) before they are impregnated with fiber. This process resulted in improved flexural strength and moisture resistant properties of the composites.

For example, a 1% addition of 3-aminopropyltriethoxysilane directly in the polyester resin resulted in about 20% increase in the flexural strength and more than 50% improvement in the water resistance properties in relation to an untreated resin.

1. A process for preparing a moldable non-woven short or discontinuous cellulosic resin impregnated mat for automotive, furniture and other cosmetic, semi-structural and structural applications, in which the process consists of forming natural fiber mat in a perforated screen, where the thermoset resin solution were circulated through the mat for certain time, where the impregnated mat were subjected to vacuum pressure to drain the excess solution, where the impregnated mat were dried at specific temperature and time and where after the dry prepreg mat were cured under specific temperature and time under pressure by compression molding and cooling the mold to a low temperature under the same pressure to obtain complex shaped molded articles.

2. A process as recited in claim 1, where in the thermoset material is a water based acrylic polymer and can be selected from the other water based thermoset polymers or low viscose thermoset polymers such as polyester, acrylic resin, vinyl ester resin and comprises less that 50 percentage by weight of the said thermoset composition.

3. A process as recited in claim 1, where in the said moldable cellulosic thermoset resin impregnated mat comprises natural fibers can be selected from bast fibers, leaf fibers, and wood fiber and comprises less than 90 percentage by weight of the said fiber composition.

4. A moldable non-woven cellulosic thermoset resin impregnated mat prepared as in claims 1, and 3 where in the cellulosic fibers comprise of wood fibers and bast fibers with a length of 0.5 centimeter to 30 centimeter.

5. A said moldable non-woven cellulosic thermoset resin impregnated mat as cited in claims 1, 3, and 4, where in the fibers can be selected from hemp, flax, jute and kenaf, sisal and coir and/or combination of the same.

6. A processes recited in claim 1, where in the impregnation of non-woven cellulosic mat by the circulation of the resin solution with 5-30 percentage resin content for 0.3-15 minutes.

7. A process recited in claim 1, where in the vacuum impregnation to drain the excess solution under 50-1000 psi for a residence time of 0.1-10 minutes.

8. A process recited in claim 1, where in the drying temperature of fiber and composite at 30-100 degree centigrade for 0.5-48 hours.

9. A process comprising the manufacture of the cellulosic fiber thermoset based composites by compression molding of the said composition in claims 1-8 under a pressing device ranging from 10-50 tones and within a temperature range of 50-240 degree centigrade for 1-30 minutes.

10. A process comprising the manufacture of the cellulosic fiber thermoset based composites by compression molding of the said composition in claims 1-8 with a temperature less than 240 degree centigrade, more specifically less than 220 degree centigrade.

11. A process comprising the manufacture of the cellulosic fiber thermoset based composites by compression molding of the said composition in claims 1-10 with a cooling process to a temperature less than 60 centigrade.

12. A process comprising the manufacture of the cellulosic fiber thermoset composites by compression molding of the said composition in claims 1-10 with a small amount of adhesion promoters added to the resin. More specifically, a polysiloxane such as 3-aminopropyltriethoxysilane is added to the resin in less than 3% before composite is manufactured.

13. The said composite of claims 1-11, where in the said thermoset composites material comprises less than 50 percentage by weight of the said thermoset, a water based polymer such as acrylic polymer or other water based polymers or low viscose polymers such as vinyl ester, polyester, soy ester and polyol based-resin.

14. The said composite of claims 9-11, where in the said composite product comprises less than 90 percentage by weight of the cellulosic fiber selected from bast fibers, leaf fibers and wood fibers and any contain up to 6% by weight of glass fiber.

15. The said composite of claims 9-11, where in the said composite product comprises less than 90 percentage by weight of the cellulosic fiber selected from bast fibers, leaf fibers and wood fibers.

16. The composite product of claims 9-11, where in the cellulosic fibers comprise of bast fiber with a length of 0.5 -30 centimeter; more specifically a length of 5 to 10 cm.

17. The said composite product of claim 9-11, and 16, where in the bast fibers can be selected from hemp, flax, jute and kenaf and/or a combination of the same.

18. The said composite products of claim 1-17 are used for cosmetic applications in automotive industry and can also be used for other semi-structural and structural complex shapes applications.
